(19) United States
(12) Patent Application Publication
(10) Pub. No.: US 2024/0088439 A1
(43) Pub. Date: Mar. 14, 2024

(54) ELECTROLYTE FOR LITHIUM SECONDARY BATTERY AND LITHIUM SECONDARY BATTERY INCLUDING ELECTROLYTE

(71) Applicant: Samsung SDI Co., Ltd., Yongin-si (KR)

(72) Inventors: Jinhyeok Lim, Yongin-si (KR); Yunhee Kim, Yongin-si (KR); Wonseok Cho, Yongin-si (KR); Sujeong Koh, Yongin-si (KR); Jinah Seo, Yongin-si (KR); Erang Cho, Yongin-si (KR)

(21) Appl. No.: 18/233,773

(22) Filed: Aug. 14, 2023

(30) Foreign Application Priority Data
Aug. 16, 2022 (KR) 10-2022-0102176

(51) Int. Cl. H01M 10/0567; H01M 4/1315; H01M 10/0568; H01M 10/0569

(52) U.S. Cl. CPC H01M 10/0567; H01M 4/1315; H01M 10/0568; H01M 10/0569; H01M 10/052

(57) ABSTRACT

An electrolyte for a lithium secondary battery and a lithium secondary battery including the electrolyte are disclosed. The electrolyte may include a lithium salt, an organic solvent, and a compound represented by Formula 1:

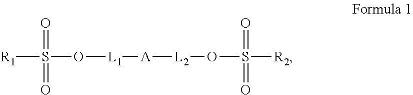

where, in Formula 1, A is oxygen or sulfur.

### CROSS-REFERENCE TO RELATED APPLICATION

This application claims priority to and the benefit of Korean Patent Application No. 10-2022-0102176, filed on Aug. 16, 2022, in the Korean Intellectual Property Office, the content of which is incorporated by reference herein in its entirety.

### BACKGROUND

### 1. Field

One or more embodiments of the present disclosure relate to an electrolyte for a lithium secondary battery and a lithium secondary battery including the electrolyte.

### 2. Description of the Related Art

Lithium secondary batteries are utilized as power sources of (e.g., to drive) portable electronic devices, such as camcorders, mobile phones, and/or laptop computers. The lithium secondary batteries are rechargeable at high rates and have a higher energy density per unit weight than that of the (related art) lead storage batteries, nickel-cadmium (Ni—Cd) batteries, nickel-hydrogen batteries, and/or nickel-zinc batteries.

A lithium secondary battery operating at a high driving voltage may be incompatible with an aqueous electrolyte that is highly reactive to lithium. An organic electrolyte is generally utilized as the electrolyte for a lithium secondary battery. An organic electrolyte is prepared by dissolving a lithium salt in an organic solvent. An appropriate or suitable organic solvent may be stable at high voltages, may have a high ionic conductivity, a high dielectric constant, and a low viscosity.

Utilizing an organic electrolyte including a lithium salt in a lithium secondary battery may cause a side reaction between a negative electrode and/or a positive electrode and the organic electrolyte, and consequentially lead to a decrease in lifespan characteristics and high-temperature stability of the lithium secondary battery.

Therefore, there should be a demand or desire for an electrolyte of a lithium secondary battery that can provide the lithium secondary battery with improved lifespan characteristics and/or high-temperature stability.

### SUMMARY

One or more aspects of embodiments of the present disclosure are directed toward an electrolyte for a lithium secondary battery, which may improve battery performance.

One or more aspects of embodiments of the present disclosure are directed toward a lithium secondary battery with improved performance by including the electrolyte for a lithium secondary battery.

Additional aspects will be set forth in part in the description which follows and, in part, will be apparent from the description, or may be learned by practice of the presented embodiments of the disclosure.

According to one or more embodiments of the present disclosure, an electrolyte for a lithium secondary battery may include a lithium salt, an organic solvent, and a compound represented by Formula 1:

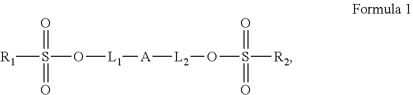

wherein, in Formula 1, L₁ and L₂ may each independently be an unsubstituted or substituted C₁-C₂₀ alkylene group, an unsubstituted or substituted C₂-C₄ alkynylene group, an unsubstituted or substituted C₆-C₂₀ arylene group, or an unsubstituted or substituted C₆-C₂₀ heteroarylene group,

A may be oxygen (O) or sulfur (S), and

R₁ and R₂ may each independently be selected from hydrogen, deuterium, a fluoro group (—F), a chloro group (—Cl), a bromo group (—Br), an iodo group (—I), a hydroxyl group, a cyano group, a nitro group, an amino group, an am idino group, a hydrazine group, a hydrazone group, a carboxylic acid group or a salt thereof, a sulfonic acid group or a salt thereof, a phosphoric acid group or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non-aromatic condensed polycyclic group, a substituted or unsubstituted monovalent non-aromatic condensed heteropolycyclic group, —N(Q₁)(Q₂), and —B(Q₆)(Q₇), wherein Q₁, Q₂, Q₆, and Q₇ may each independently be hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, or a monovalent non-aromatic condensed heteropolycyclic group.

According to one or more embodiments of the present disclosure, a lithium secondary battery may include a positive electrode including a positive active material,

a negative electrode including a negative active material, and

the electrolyte between the positive electrode and the negative electrode.

### BRIEF DESCRIPTION OF THE DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and advantages of certain embodiments of the disclosure will be more apparent from the following description taken in conjunction with the accompanying drawings, in which:

FIG. 1 is a schematic view of a lithium secondary battery according to one or more embodiments of the present disclosure;

FIG. 2 is a graph showing changes in gas volume during a high temperature storage period of lithium secondary batteries of Examples 1 to 5 and Comparative Example 1 according to one or more embodiments of the present disclosure; and

FIG. 3 is a graph showing changes in capacity during a high temperature storage period of lithium secondary batteries of Examples 1 to 5 and Comparative Example 1 according to one or more embodiments of the present disclosure.

### DETAILED DESCRIPTION

Reference will now be made in more detail to embodiments, examples of which are illustrated in the accompanying drawings, wherein like reference numerals refer to like elements throughout the present disclosure, and duplicative descriptions thereof may not be provided for conciseness. In this regard, the embodiments of the present disclosure may have different forms and should not be construed as being limited to the descriptions set forth herein. Accordingly, the embodiments of the present disclosure are merely described, by referring to the drawings, to explain aspects of the present disclosure. As utilized herein, the terms “and/or” and “or” may include any and all combinations of one or more of the associated listed items. Expressions such as “at least one of,” when preceding a list of elements, modify the entire list of elements and do not modify the individual elements of the list.

Hereinafter, an electrolyte for a lithium secondary battery and a lithium secondary battery including the electrolyte according to one or more embodiments of the present disclosure will be described in more detail.

An electrolyte for a lithium secondary battery according to one or more embodiments of the present disclosure may include: a lithium salt; an organic solvent; and a compound represented by Formula 1:

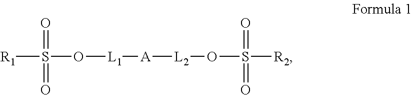

wherein, in Formula 1, L₁ and L₂ may each independently be an unsubstituted or substituted C₁-C₂₀ alkylene group, an unsubstituted or substituted C₂-C₄ alkynylene group, an unsubstituted or substituted C₆-C₂₀ arylene group, or an unsubstituted or substituted C₆-C₂₀ heteroarylene group,

A may be oxygen (O) or sulfur (S), and

R₁ and R₂ may each independently be selected from hydrogen, deuterium, a fluoro group (—F), a chloro group (—Cl), a bromo group (—Br), an iodo group (—I), a hydroxyl group, a cyano group, a nitro group, an amino group, an am idino group, a hydrazine group, a hydrazone group, a carboxylic acid group or a salt thereof, a sulfonic acid group or a salt thereof, a phosphoric acid group or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non-aromatic condensed polycyclic group, a substituted or unsubstituted monovalent non-aromatic condensed heteropolycyclic group, —N(Q₁)(Q₂), and —B(Q₆)(Q₇), wherein Q₁, Q₂, Q₆, and Q₇ may each independently be hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, or a monovalent non-aromatic condensed heteropolycyclic group.

A substituent of the substituted C₁-C₂₀ alkyl group, substituted C₂-C₂₀ alkenyl group, substituted C₂-C₂₀ alkynyl group, substituted C₁-C₂₀ alkoxy group, substituted C₃-C₂₀ cycloalkyl group, substituted C₂-C₂₀ heterocycloalkyl group, substituted C₃-C₂₀ cycloalkenyl group, substituted C₂-C₂₀ heterocycloalkenyl group, substituted C₆-C₂₀ aryl group, substituted C₆-C₂₀ aryloxy group, substituted C₆-C₂₀ arylthio group, substituted C₂-C₂₀ heteroaryl group, substituted monovalent non-aromatic condensed polycyclic group, and substituted monovalent non-aromatic condensed heteropolycyclic group may be, for example, —F, —Cl, —Br, —I, a hydroxyl group, a cyano group, a nitro group, or at least one R. The at least one R may be: deuterium (—D), —F, —Cl, —Br, —I, a hydroxyl group, a cyano group, or a nitro group; a C₁-C₃₀ alkyl group, a C₂-C₃₀ alkenyl group, a C₂-C₃₀ alkynyl group, or a C₁-C₃₀ alkoxy group; a C₃-C₃₀ carbocyclic group, a C₁-C₃₀ heterocyclic group, a C₆-C₃₀ aryloxy group, a C₆-C₃₀ arylthio group, a C₇-C₃₀ aryl alkyl group, or a C₂-C₃₀ heteroaryl alkyl group; or —Si(Q₁)(Q₂)(Q₃), —N(Q₁)(Q₂), —B(Q₁)(Q₂), —C(═O)(Q₁), —S(═O)2(Q₁), or —P(═O)(Q₁)(Q₂), wherein Q₁ to Q₃ may each independently be: hydrogen; deuterium; —F; —Cl; —Br; —I; a hydroxyl group; a cyano group; a nitro group; a C₁-C₃₀ alkyl group; a C₂-C₃₀ alkenyl group; a C₂-C₃₀ alkynyl group; a C₁-C₃₀ alkoxy group; a C₃-C₃₀ carbocyclic group; a C₁-C₃₀ heterocyclic group; a C₇-C₃₀ aryl alkyl group; or a C₂-C₃₀ heteroaryl alkyl group.

During initial charging of the lithium secondary battery, lithium ions from a positive electrode, i.e., lithium metal oxide electrode, may migrate to a negative electrode, i.e., a carbon electrode, and intercalate with carbon. Here, as lithium is highly reactive, lithium may react with the carbon electrode to produce Li₂CO₃, LiO, LiOH, etc. to form a film on a surface of the negative electrode. Such a film is referred to as a solid electrolyte interface (SEI) film. There is a problem in that gas is generated inside a battery due to decomposition of the carbonate-based organic solvent during SEI film formation reaction. Such gas may be CO₂ and/or the like depending on the type or kind of non-aqueous organic solvent and negative active material.

Due to generation of gas inside the battery, the thickness of the battery may expand during charging. In some embodiments, when storing at high temperature after charging, a passivation layer gradually collapses due to the increased electrochemical energy and thermal energy over time, so that side reactions between the exposed negative electrode surface and the surrounding electrolytes continue to occur.

The same problem as above may also occur in the positive electrode.

In particular, when utilizing a positive active material utilizing lithium transition metal oxide with a nickel content (e.g., amount) of 80 mol % or more, a lithium secondary battery with high output and large capacity may be manufactured. However, the positive active material with high nickel content (e.g., amount) has an unstable surface structure, and gas generation by side reaction may increase during the charging and discharging process of the battery. In some embodiments, as resistance is increased at high temperatures, it is necessary to improve stability at high temperatures. In particular, when stored at a high temperature in a fully charged state (for example, 100% charging at 4.2 V and being left at 85° C. for 4 days), the passivation layer is gradually collapsed by the increased electrochemical and thermal energy over time, and a side reaction of the surrounding electrolytes with the exposed surface of the positive electrode is initiated. The main gases generated at this time may be CO₂, CH₄, C₂H₆, etc., which are generated by decomposition of a carbonate-based organic solvent. Lithium secondary batteries utilizing these positive active materials require improvement because lifespan characteristics thereof may deteriorate.

The present disclosure provides a scheme or embodiment to solve the foregoing problems and provides an electrolyte additive for a lithium secondary battery capable of suppressing gas generation when left at a high temperature.

The electrolyte for a lithium secondary battery according to one or more embodiments may improve effects of suppressing gas generation by forming a heat-resistant film on a surface of an electrode by utilizing the compound represented by Formula 1 as described above as an additive. As a result, when utilizing such an electrolyte, the manufactured lithium secondary batteries exhibit reduced internal resistance. In one or more embodiments, the manufactured lithium secondary batteries show an improved lifespan and high-temperature stability due to excellent or suitable resistance suppression effects at a high temperature.

Hereinafter, the reason for which performance of a lithium secondary battery is improved by utilizing the compound represented by Formula 1 as an electrolyte additive will be described in greater detail. However, the description is for understanding the present disclosure only and is not intended to limit the scope of the present disclosure.

As a lithium salt included in the electrolyte, LiPF₆ is generally utilized, but LiPF₆ has problems such as poor thermal stability and easy hydrolysis even with moisture. Thus, LiPF₆-containing electrolytes show instability when exposed to moisture and high temperatures. A decomposition product of LiPF₆ is one of main factors contributing to changes in a composition and stability of a negative electrode interface. Residual moisture and/or surface hydroxyl groups may react with PF₆ anions in solution (e.g., in the electrolyte) to form HF and release PF₅. The HF released may gradually deteriorate electrochemical performance by corroding the positive electrode.

When the compound represented by Formula 1 is utilized as an electrolyte additive, an —OS(═O)₂-group included in the compound represented by Formula 1 may form a bond with a metal ion of a positive active material, and oxygen or sulfur is utilized as A, and when a compound in which electron-rich groups on right and left of A is utilized, a heat-resistant film may be formed on a surface of a positive electrode and/or a negative electrode. And the heat-resistant film may form a SEI film with high temperature stability and excellent or suitable ion conductivity on the surface of the positive electrode and/or the negative electrode, and may suppress or reduce the side reaction of LiPF₆ due to —PO₂F functional group. Here, non-limiting examples of an electron-rich groups may include oxygen, sulfur, and/or the like.

As a result, gas generation due to the decomposition reaction of the electrolyte inside the lithium secondary battery may be suppressed or reduced during high-temperature storage, and the cycle lifespan characteristics may be improved. In some embodiments, swelling of the lithium secondary battery may be prevented or reduced due to suppression of gas generation.

In one or more embodiments, by including the compound represented by Formula 1 in the electrolyte, a low resistance SEI film and/or protective layer may be formed, and thus a lithium secondary battery with reduced internal resistance may be obtained.

In one or more embodiments, the compound represented by Formula 1 strongly interacts with the transition metal ion of the positive electrode to completely cap and inactivate a reaction center on a surface of the positive electrode, thereby preventing or reducing dissolution of the transition metal and oxidation of the solvent. For example, a cathode electrolyte interphase (CEI) film with low impedance characteristics may be formed on a surface of the positive electrode. The CEI film may prevent or reduce formation of by-products such as gas and HF by preventing or reducing electrolyte oxidation and may improve cycle stability and rate performance by preventing or reducing a structure of the electrode from being destroyed. In some embodiments, as the CEI film is formed, the resistance at the interface between the electrolyte and the positive electrode may be lowered to improve lithium ion conductivity, thereby increasing the low-temperature discharge voltage. The compound represented by Formula 1 may form a composite by coordinating to a thermal decomposition product of a lithium salt such as LiPF₆ or an anion dissociated from the lithium salt, and due to the formation of such composites, the thermal decomposition product of the lithium salt or the anion dissociated from the lithium salt may be stabilized, thereby suppressing undesired side reactions with the electrolyte. Thus, along with improvement of cycle lifespan characteristics, it may also significantly reduce occurrence rate of defects of a lithium secondary battery by preventing or reducing gas from being generated inside the lithium secondary battery.

A content (e.g., amount) of the compound represented by Formula 1 may be in a range of about 0.1 percent by weight (wt %) to about 5 wt %, based on a total weight of the electrolyte. When the content (e.g., amount) of the compound represented by Formula 1 is within this range, the high temperature storage properties may be improved to suppress or reduce gas generation when left high-temperature storage and effectively prevent or reduce the increase in interface resistance, and thus, a lithium secondary battery with improved high-temperature characteristics and resistance characteristics may be manufactured or formed without deterioration of lifespan characteristics.

In one or more embodiments, the compound represented by Formula 1 may be the compound represented by Formula 2:

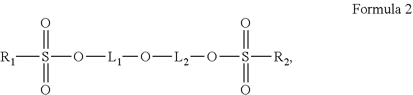

wherein, in Formula 2, L₁ and L₂ may each independently be an unsubstituted or substituted C₁-C₂₀ alkylene group, an unsubstituted or substituted C₂-C₄ alkynylene group, an unsubstituted or substituted C₆-C₂₀ arylene group, or an unsubstituted or substituted C₆-C₂₀ heteroarylene group, and

R₁ and R₂ may each independently be selected from hydrogen, deuterium, a fluoro group (—F), a chloro group (—Cl), a bromo group (—Br), an iodo group (—I), a hydroxyl group, a cyano group, a nitro group, an amino group, an amidino group, a hydrazine group, a hydrazone group, a carboxylic acid group or a salt thereof, a sulfonic acid group or a salt thereof, a phosphoric acid group or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non-aromatic condensed polycyclic group, a substituted or unsubstituted monovalent non-aromatic condensed heteropolycyclic group, —N(Q₁)(Q₂), and —B(Q₆)(Q₇), wherein Q₁, Q₂, Q₆, and Q₇ may each independently be hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, or a monovalent non-aromatic condensed heteropolycyclic group.

In one or more embodiments, L₁ and L₂ in Formula 2 may each be an unsubstituted or substituted C₁-C₂₀ alkylene group, and for example, an ethylene group, a propylene group, or a butylene group.

In one or more embodiments, L₁ and L₂ may each be an electron-rich group. Here, oxygen or sulfur may be an example of an electron-rich group. In embodiments of utilizing an electrolyte containing the compound of Formula 1 having an electron-rich group, gas suppression effect may be more improved when the lithium secondary battery is left at high temperature. When an electron-rich group exists, a stabilizing effect may be obtained by forming a chemical bond with a transition metal cation of the positive electrode. When a compound consisting only of a carbon chain (a material structure) is utilized, a resistance of a film increases, and a contact frequency decreases as the main moieties acting on a surface of the positive electrode are located at both ends of the structure, however, when electron-rich oxygen and sulfur elements are inserted in the middle of the chain, the positive electrode transition metal stabilization effect is excellent or suitable, thus forming radicals for forming a film.

In one or more embodiments, the compound represented by Formula 1 may be, for example, a compound represented by Formula 3:

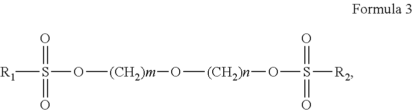

wherein, in Formula 3, R₁ and R₂ may each be a substituted or unsubstituted C₁-C₂₀ alkyl group, and

m and n may each independently be an integer from 1 to 10.

In Formula 3, m and n may each independently be an integer from 1 to 5 or 2 to 4.

In Formula 3, R₁ and R₂ may each be a C₁-C₂₀ alkyl group.

In Formula 3, m and n may each independently be 2 or 3.

In one or more embodiments, the compound represented by Formula 1 may be, for example, selected from compounds represented by Formulae 4 to 6:

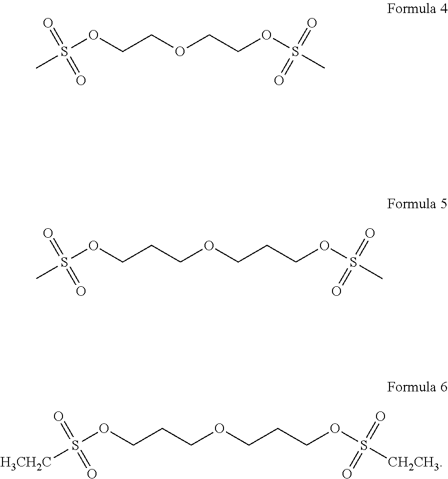

In one or more embodiments, the lithium salt may be at least one selected from the group consisting of LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), LiPO₂F₂, and compounds represented by Formulae 7 to 10. However, embodiments of the present disclosure are not limited thereto, and any suitable lithium salt that may be utilized as a lithium salt in the art may be utilized.

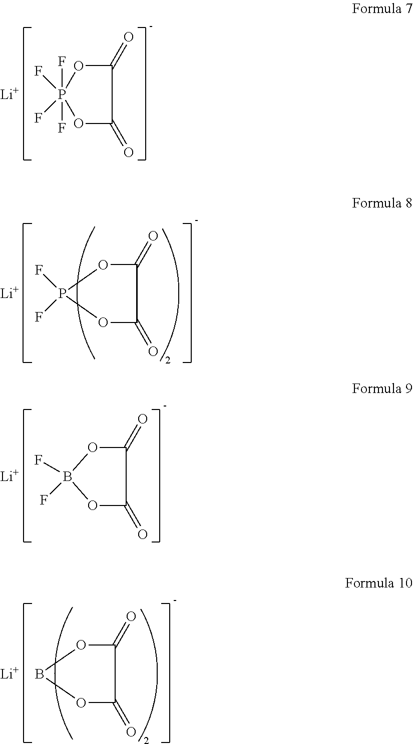

The concentration of the lithium salt in the electrolyte may be in a range of about 0.01 M to about 5.0 M, for example, about 0.05 M to about 5.0 M, for example, about 0.1 M to about 5.0 M, or for example, about 0.1 M to about 2.0 M. When the concentration of the lithium salt is within any of these ranges, more improved lithium secondary battery characteristics may be obtained.

The organic solvent may be at least one selected from a carbonate-based solvent, an ester-based solvent, an ether-based solvent, and a ketone-based solvent.

The carbonate-based solvent may be ethylmethyl carbonate (EMC), methylpropyl carbonate (MPC), ethylpropyl carbonate (EPC), dimethyl carbonate (DMC), diethyl carbonate (DEC), dipropyl carbonate (DPC), propylene carbonate (PC), ethylene carbonate (EC), or butylene carbonate (BC). The ester-based solvent may be methyl propionate, ethyl propionate, ethyl butyrate, methyl acetate, ethyl acetate, n-propyl acetate, dimethyl acetate, γ-butyrolactone, decanolide, γ-valerolactone, mevalonolactone, or caprolactone. The ether-based solvent may be dibutyl ether, tetraglyme, diglyme, dimethoxyethane, 2-methyl tetrahydrofuran, or tetrahydrofuran. The ketone-based solvent may be cyclohexanone. The nitrile-based solvent may be acetonitrile (AN), succinonitrile (SN), or adiponitrile. As other solvents, dimethyl sulfoxide, dimethyl formamide, dimethyl acetamide, tetrahydrofuran, etc. may be utilized, but embodiments of the present disclosure are not necessarily limited thereto. Any suitable solvent that may be utilized as an organic solvent in the art may be utilized. For example, in some embodiments, the organic solvent may include a mixed solvent of chain carbonate in a range of about 50 percent by volume (vol %) to about 95 vol % and cyclic carbonate about 5 vol % to about 50 vol %, for example, a mixed solvent of chain carbonate in a range of about 70 vol % to about 95 vol % and cyclic carbonate about 5 vol % to about 30 vol %. For example, in some embodiments, the organic solvent may be a mixture of three or more organic solvents.

In some embodiments, the organic solvent may include at least one selected from the group consisting of ethylmethyl carbonate (EMC), methylpropyl carbonate, ethylpropyl carbonate, dimethyl carbonate (DMC), diethyl carbonate(DEC), dipropyl carbonate, propylene carbonate (PC), ethylene carbonate (EC), fluoroethylene carbonate (FEC), vinylene carbonate (VC), vinylethylene carbonate (VEC), butylene carbonate, ethyl propionate, ethyl butyrate, dimethyl sulfoxide, dimethyl formamide, dimethyl acetamide, γ-valerolactone, γ-butyrolactone, and tetrahydrofuran. However, embodiments of the present disclosure are not limited thereto, and any suitable organic solvent that may be utilized in the art may be utilized.

In one or more embodiments, the electrolyte for a lithium secondary battery according to one or more embodiments may further contain a disultone-based compound. The disultone-based compound may have a higher reduction potential than the compound represented by Formula 1, and thus, the disultone-based compound may prevent or reduce over-decomposition of the compound represented by Formula 1 by participating in formation of the SEI film in advance, and accordingly, the SEI film and/or protective layer having a low resistance may be formed due to suppression of side reaction with the electrolyte. The compound of Formula 1, of which over-decomposition is suppressed or reduced due to the disultone-based compound, may reduce the side reaction of the electrolyte by suppressing high-temperature thermal decomposition of lithium salt during high-temperature storage.

A content (e.g., amount) of the disultone-based compound may be, for example, about 0.05 wt % to about 20 wt %, about 0.1 wt % to about 10 wt %, about 0.5 wt % to about 5 wt %, about 1 wt % to about 3 wt %, or about 1.5 wt % to about 2.5 wt %, based on a total weight of the electrolyte. When the content (e.g., amount) of the disultone-based compound is within any of these ranges, the capacity and lifespan may be further improved by suppressing the increase in interfacial resistance, and the electrolyte decomposition reaction may be suppressed or reduced by forming an SEI film with low resistance and excellent or suitable thermal stability.

In one or more embodiments, the disultone-based compound may be, for example, a compound represented by Formula 11:

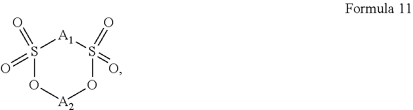

wherein, in Formula 11, A₁ and A₂ may each independently be: a substituted or unsubstituted C₁-C₅ alkylene group; a carbonyl group; a sulfinyl group; or a C₂-C₆ divalent group in which a plurality of substituted or unsubstituted alkylene units are bound via an ether bond.

In one or more embodiments, the disultone-based compound may be, for example, a compound represented by Formula 11-1:

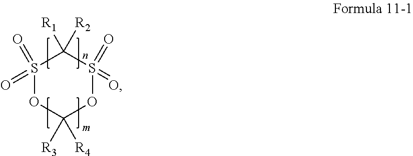

wherein, in Formula 11-1, R₁ to R₄ may each independently be hydrogen, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₃-C₂₀ cycloalkyl group, a substituted or unsubstituted C₆-C₂₀ aryl group, or a substituted or unsubstituted C₂-C₂₀ heteroaryl group,

n may be an integer of 0 or 1, and

m may be an integer from 1 to 5.

In one or more embodiments, the compound represented by Formula 11 may be, for example, at least one selected from compounds represented by Formulae 11-2 to 11-19:

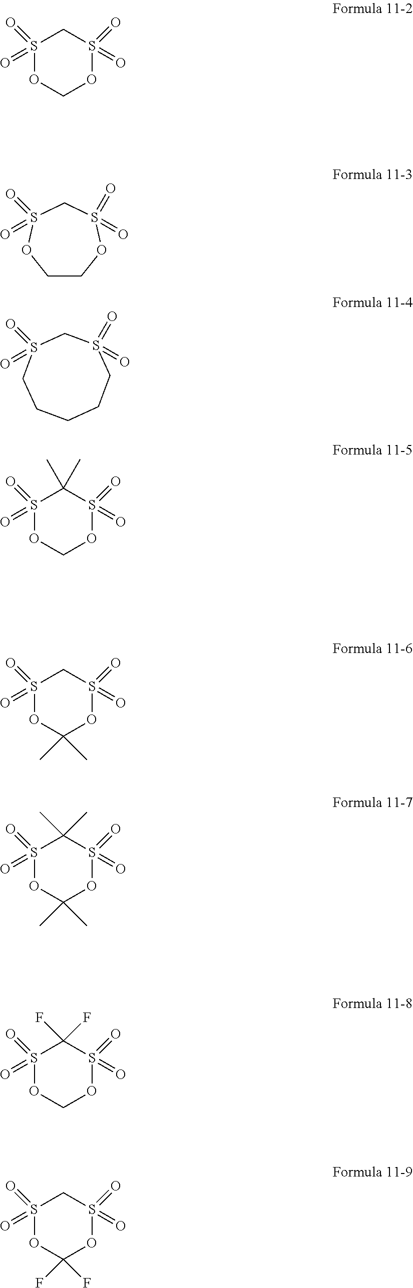

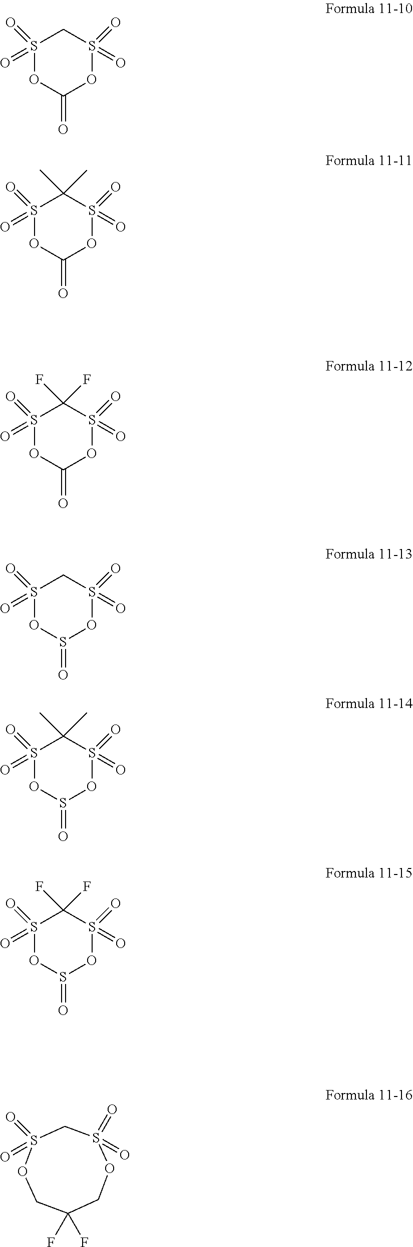

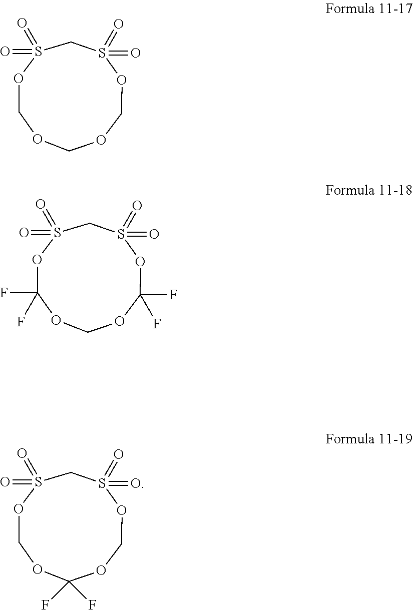 [SMILES: O=S1(=O)CS(=O)(=O)OCOCOCO1 ; O=S1(=O)CS(=O)(=O)OC(F)(F)OCOC(F)(F)O1 ; O=S1(=O)CS(=O)(=O)OCOC(F)(F)OCO1]

The electrolyte may be a liquid or gel electrolyte. The electrolyte may be prepared by adding a lithium salt and the aforementioned additives to an organic solvent.

According to one or more embodiments, a lithium secondary battery may include: a positive electrode including a positive active material; a negative electrode including a negative active material; and the electrolyte between the positive electrode and the negative electrode.

By including the electrolyte additive for a lithium secondary battery, the lithium secondary battery suppresses the increase in initial resistance of the lithium secondary battery, suppresses gas generation by side reaction, and improves lifespan characteristics.

In one or more embodiments, positive active materials may include lithium transition metal oxide including nickel and other transition metals. A nickel content (e.g., amount) of the lithium transition metal oxide including nickel and other transition metals may be 60 mol % or more, for example, 75 mol % or more, for example, 80 mol % or more, for example, 85 mol % or more, or for example, 90 mol % or more, based on the total mole number of transition metal in the lithium transition metal oxide.

For example, in some embodiments, the lithium transition metal oxide may be a compound represented by Formula 12:

LiₐNiₓCo_{y}M_{z}O_{2-b}X_{b}, Formula 12

wherein, in Formula 12, 1.0≤a≤1.2, 0≤b≤0.2, 0.6≤x≤1, 0≤z≤0.3, 0<z≤0.3, and x+y+z=1, M may be at least one selected from the group consisting of manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), and boron (B), and

X may be F, S, Cl, Br, or a combination thereof.

In Formula 12, for example, 0.7≤x≤1, 0≤y≤0.3, 0≤z≤0.3; 0.8≤x≤1, 0≤y≤0.3, 0≤z≤0.3; 0.8≤x≤1, 0≤y≤0.2, 0≤z≤0.2; 0.83≤x≤0.97, 0≤y0.15, 0≤z≤0.15; or 0.85x≤0.95, 0≤y≤0.1, 0≤z≤0.1.

For example, in one or more embodiments, the lithium transition metal oxide may be at least one selected from compounds represented by Formulae 12-1 and 12-2:

LiNiₓCo_{y}Mn_{z}O₂, Formula 12-1

wherein, in Formula 12-1, 0.6x≤0.95, 0<00.2, 0<z≤0.1. For example, 0.7x≤0.95, 0<00.3, 0<z≤0.3.

LiNiₓCo_{y}Al_{z}O₂, Formula 12-2

wherein, in Formula 12-2, 0.6x≤0.95, 0≤y≤0.2, 0≤z≤0.1. For example, 0.7x≤0.95, 0≤y≤0.3, 0≤z≤0.3. For example, 0.8≤x≤0.95, 0y≤0.3, 0≤z≤0.3. For example, 0.82x≤0.95, 0≤y≤0.15, 0≤z≤0.15. For example, 0.85x≤0.95, 0≤y≤0.1, 0<z≤1.

For example, in one or more embodiments, the lithium transition metal oxide may be LiNi_{0.6}Co_{0.2}Mn._{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.8}Co_{0.1}Mn_{0.2}O₂, or LiNi_{0.88}Co_{0.1}Al_{0.02}O₂.

According to one or more embodiments of the present disclosure, the positive active material may include at least one active material selected from the group consisting of Li—Ni—Co—Al (NCA), Li—Ni—Co—Mn (NCM), lithium cobalt oxide (LiCoO₂), lithium manganese oxide (LiMnO₂), lithium nickel oxide (LiNiO₂), and lithium iron phosphate (LiFePO₄).

In one or more embodiments, the negative active material may include at least one selected from a silicon-based compound, a carbonaceous material, a composite of a silicon-based compound and a carbon-based compound, and silicon oxide (SiOₓ, wherein 0<x<2). The silicon-based compound may be a silicon particle, a silicon alloy particle, and/or the like.

The size of the silicon-based compound may be less than 200 nm, for example, about 10 nm to about 150 nm. The term “size” may indicate an average particle diameter when the silicon-based compound is spherical or an average major axis length when the silicon particle is non-spherical.

When the size of the silicon-based compound is within this range, lifespan characteristics of the silicon-based compound may be excellent or suitable, and thus, lifespan of a lithium secondary battery is further improved when the electrolyte according to one or more embodiments is utilized.

Non-limiting examples of the carbonaceous material may include crystalline carbon, amorphous carbon, and mixtures thereof. Non-limiting examples of the crystalline carbon may include graphite, such as natural graphite or artificial graphite that are in shapeless (e.g., irregular), plate, flake, spherical, or fibrous form. Non-limiting examples of the amorphous carbon may include soft carbon (carbon sintered at low temperatures), hard carbon, meso-phase pitch carbides, and sintered cokes.

The composite of the silicon-based compound and the carbon-based compound may be: a composite having a structure in which silicon nanoparticles are placed on top of a carbon-based compound; a composite containing silicon particles on a surface and inside a carbon-based compound; or a composite in which silicon particles are coated with a carbon-based compound and included inside the carbon-based compound. In the composite of the silicon-based compound and the carbon-based compound, the carbon-based compound may be graphite, graphene, graphene oxide, or a combination thereof.

The composite of the silicon-based compound and the carbon-based compound may be an active material obtained by carbon coating after dispersing silicon nanoparticles with an average diameter of about 200 nm or less on carbon-based compound particles or an active material in which silicon (Si) particles are present on and inside graphite. The secondary particle average diameter of the composite of the silicon-based compound and the carbon-based compound may be in a range of about 5 μm to about 20 μm. The average diameter of the silicon nanoparticle may be 5 nm or more, for example, 10 nm or more, for example, 20 nm or more, for example, 50 nm or more, or 70 nm or more. The average diameter of the silicon nanoparticle may be 200 nm or less, 150 nm or less, 100 nm or less, 50 nm or less, 20 nm or less, or 10 nm or less. For example, in some embodiments, the average diameter of the silicon nanoparticle may be in a range of about 100 nm to about 150 nm.

The secondary particle average diameter of the composite of the silicon-based compound and the carbon-based compound may be in a range of about 5 μm to about 18 μm, for example, about 7 μm to about 15 μm, or for example, about 10 μm to about 13 μm.

Non-limiting examples of the composite of the silicon-based compound and the carbon-based compound may include a porous silicon composite cluster disclosed in Korean Patent Publication 10-2018-0031585 and a porous silicon composite cluster structure disclosed in Korean Patent Publication 10-2018-0056395. Korean Patent Publication No. 10-2018-0031585 and Korean Patent Publication No. 10-2018-0056395 are incorporated as references by the present disclosure in their entirety.

The composite of the silicon-based compound and the carbon-based compound according to one or more embodiments may be a porous silicon composite cluster including a porous core containing porous silicon composite secondary particles and a shell disposed on the porous core and containing second graphene, the porous silicon composite secondary particles may include an aggregate of two or more silicon composite primary particles, and the silicon composite primary particles may be a porous silicon composite cluster including silicon, silicon oxide (SiOx) (where 0<x<2) disposed on the silicon, and first graphene disposed on the silicon oxide.

The porous silicon composite cluster structure may include a porous silicon composite cluster including porous silicon composite secondary particles and a second carbon flake on at least one surface of the porous silicon composite secondary particles, and a carbon-based coating film containing amorphous carbon and disposed on the porous silicon composite cluster, the porous silicon composite secondary particles may include an aggregate of two or more silicon composite primary particles, the silicon composite primary particles may include silicon; a silicon oxide (SiOx) (0<x<2) on at least one surface of the silicon, and a first carbon flake on at least one surface of the silicon oxide, and the silicon oxide may exist in the state of a film, a matrix, or a combination thereof.

Each of the first carbon flake and the second carbon flake may exist in the form of a film, particle, a matrix, or a combination thereof. In some embodiments, each of the first carbon flake and the second carbon flake may be graphene, graphite, carbon fiber, graphene oxide, and/or the like.

In one or more embodiments, the composite of the silicon-based compound and the carbon-based compound may be: a composite having a structure in which silicon nanoparticles are placed on top of a carbon-based compound; a composite containing silicon particles on a surface and inside a carbon-based compound; or a composite in which silicon particles are coated with a carbon-based compound and included inside the carbon-based compound. In the composite of the silicon-based compound and the carbon-based compound, the carbon-based compound may be graphite, graphene, graphene oxide, or a combination thereof.

The lithium secondary battery may be any type or kind of a lithium secondary battery, e.g., a lithium ion battery, a lithium ion polymer battery, or a lithium sulfur battery.

The lithium secondary battery may be manufactured as follows.

First, a positive electrode is prepared.

For example, in one or more embodiments, a positive active material, a conductive agent, a binder, and a solvent are mixed to prepare a positive active material composition. In one or more embodiments, the positive active material composition may be directly coated on a metallic current collector to prepare a positive electrode plate. In one or more embodiments, the positive active material composition may be cast on a separate support to form a positive active material film, which may then be separated from the support and laminated on a metallic current collector to prepare a positive electrode plate. The positive electrode is not limited to the examples described above, and may be one of a variety of types (kinds).

The positive active material may be any positive active material available in the art, and for example, may be a lithium-containing metal oxide. For example, at least one composite oxide of a metal selected from cobalt, manganese, nickel, and a combination thereof and lithium may also be utilized. Non-limiting examples thereof may include a compound represented by any one of: LiₐA_{1-b}B¹_{b}D¹₂ (wherein 0.90≤a≤1.8, and 0≤b≤0.5); LiₐE_{1-b}B¹_{b}O_{2-c}D¹_{c} (wherein 0.90≤a≤1.8, 0≤b≤0.5, and 0c≤0.05); LiE_{2-b}B¹_{b}O_{4-c}D¹_{c} (wherein 0≤b≤0.5 and 0≤c≤0.05); LiₐNi_{1-b-c}Co_{b}B¹_{c}D¹_{α} (wherein 0.90a1.8, 0≤b≤0.05, 0≤c≤0.05 and 0<α≤2); LiₐNi_{1-b-c}Co_{b}B¹_{c}O_{2-α}F¹_{α} (wherein 0.90a≤1.8, 0≤b≤0.05, 0≤c≤0.05 and 0<α<2); LiₐNi_{1-b-c}Co_{b}B¹_{c}O_{2-α}F¹₂ (wherein 0.90a≤1.8, 0≤b≤0.05, 0≤c≤0.05 and 0<α<2); LiₐNi_{1-b-c}Mn_{b}B¹_{c}D_{α} (wherein 0.90≤a≤1.8, 0c≤0.05, and 0<α≤2); LiₐNi_{1-b-c}Mn_{b}B¹_{c}O_{2-α}F¹_{α} (wherein 0.90≤a≤1.8, 0c≤0.05, and 0<α<2); LiₐNi_{1-b-c}Mn_{b}B¹_{c}O_{2-α}F¹₂ (wherein 0.90≤a≤1.8, 0≤b≤0.5, 0c≤0.05, and 0<α<2); LiₐNi_{b}E_{c}G_{d}O₂ (wherein 0.90≤a≤1.8, 0≤b≤0.9, 0c≤0.5, and 0.001≤d≤0.1); LiₐNi_{b}Co_{c}Mn_{d}GeO₂ (wherein 0.90≤a≤1.8, 0≤b≤0.9, 0c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn2G_{b}O₄ (wherein 0.90≤a≤1.8 and 0.001≤b≤0.1); QO₂; QS₂; LiQS₂; V₂O₅; LiV₂O₅; LiIO₂; LiNiVO₄; Li_{(3-f)}J₂(PO₄)3 (0≤f≤2); Li_{3-f)}Fe₂(PO₄)₃, wherein 0≤f≤2; and LiFePO₄.

In the foregoing formulae, A may be selected from nickel (Ni), cobalt (Co), manganese (Mn), and a combination thereof; B¹ may be selected from aluminum (Al), Ni, Co, Mn, chromium (Cr), iron (Fe), magnesium (Mg), strontium (Sr), vanadium (V), a rare-earth element, and a combination thereof; D¹ may be selected from oxygen (O), fluorine (F), sulfur (S), phosphorus (P), and a combination thereof; E may be selected from Co, Mn, and a combination thereof; F¹ may be selected from F, S, P, and a combination thereof; G may be selected from Al, Cr, Mn, Fe, Mg, lanthanum (La), cerium (Ce), Sr, V, and a combination thereof; Q may be selected from titanium (Ti), molybdenum (Mo), Mn, and a combination thereof; I may be selected from Cr, V, Fe, scandium (Sc), yttrium (Y), and a combination thereof; and J may be selected from V, Cr, Mn, Co, Ni, copper (Cu), and a combination thereof.

For example, in some embodiments, the positive active material may be LiCoO₂, LiMnₓO₂ₓ (where x=1, 2), LiNi₁₋ₓMnₓO₂ₓ (where 0<x<1, LiNi_{1-x-y}CoₓMn_{y}O₂ (where 0≤x≤0.5, and 0≤y≤0.5), or LiFePO₄.

The compounds listed above as positive active materials may have a surface coating layer (hereinafter, also referred to as “coating layer”). In some embodiments, a mixture of a compound without a coating layer and a compound having a coating layer, the compounds being selected from the compounds listed above, may be utilized. In one or more embodiments, the coating layer may include at least one compound of a coating element selected from the group consisting of oxide, hydroxide, oxyhydroxide, oxycarbonate, and hydroxycarbonate of the coating element. In one or more embodiments, the compounds for the coating layer may be amorphous or crystalline. In one or more embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In one or more embodiments, the coating layer may be formed utilizing any suitable method that does not adversely affect the physical properties of the positive active material when a compound of the coating element is utilized. For example, the coating layer may be formed utilizing a spray coating method or a dipping method. The coating method may be well understood by one of ordinary skill in the art, and thus a detailed description thereof will not be provided.

In one or more embodiments, the conductive agent may be carbon black or graphite particulates, but embodiments of the present disclosure are not limited thereto. Any suitable material available as a conductive agent in the art may be utilized.

Non-limiting examples of the binder may include a vinylidene fluoride/hexafluoropropylene copolymer, polyvinylidene fluoride (PVDF), polyacrylonitrile, polymethylmethacrylate, polytetrafluoroethylene, and/or mixtures thereof, and a styrene-butadiene rubber polymer may be utilized as a binder, but embodiments of the present disclosure are not limited thereto. Any suitable material available as a binder in the art may be further utilized.

Non-limiting examples of the solvent may include N-methyl-pyrrolidone, acetone, and/or water, but embodiments of the present disclosure are not limited thereto. Any suitable material available as a solvent in the art may be utilized.

The amounts of the positive active material, the conductive agent, the binder, and the solvent may be in ranges that are commonly utilized in lithium batteries. In some embodiments, at least one selected from the conductive agent, the binder, and the solvent may not be provided according to the use and the structure of the lithium battery.

Next, a negative electrode is prepared.

For example, in one or more embodiments, a negative active material, a conductive agent, a binder, and a solvent are mixed to prepare a negative active material composition. In one or more embodiments, the negative active material composition may be directly coated on a metallic current collector and dried to prepare a negative electrode plate. In one or more embodiments, the negative active material composition may be cast on a separate support to form a negative active material film, which may then be separated from the support and laminated on a metallic current collector to prepare a negative electrode plate.

In one or more embodiments, the negative active material may be any suitable negative active material for a lithium battery available in the art. For example, the negative active material may include at least one selected from lithium metal, a metal alloyable with lithium, a transition metal oxide, a non-transition metal oxide, and a carbonaceous material.

Non-limiting examples of the metal alloyable with lithium may include silicon (Si), tin (Sn), aluminum (Al), germanium (Ge), lead (Pb), bismuth (Bi), antimony (Sb), a

Si-Y alloy (wherein Y is an alkali metal, an alkaline earth metal, a Group 13 element, a Group 14 element, a transition metal, a rare earth element, or a combination thereof, and Y is not Si), and/or a Sn—Y alloy (wherein Y is an alkali metal, an alkaline earth-metal, a Group 13 element, a Group 14 element, a transition metal, a rare earth element, or a combination thereof, and Y is not Sn). Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

For example, the transition metal oxide may be a lithium titanium oxide, a vanadium oxide, or a lithium vanadium oxide.

Non-limiting examples of the non-transition metal oxide may include SnO₂ and SiOₓ (where 0<x<2).

Non-limiting examples of the carbonaceous material may include crystalline carbon, amorphous carbon, and mixtures thereof. Non-limiting examples of the crystalline carbon may include graphite, such as natural graphite or artificial graphite that are in shapeless (e.g., irregular), plate, flake, spherical, or fibrous form. Non-limiting examples of the amorphous carbon may include soft carbon (carbon sintered at low temperatures), hard carbon, meso-phase pitch carbides, and sintered cokes.

In one or more embodiments, the conductive agent and the binder utilized for the negative active material composition may be the same as the conductive agent and the binder utilized for the positive active material composition.

The amounts of the negative active material, the conductive agent, the binder, and the solvent may be the same levels generally utilized in the art for lithium batteries. In some embodiments, at least one of the conductive agent, the binder, and the solvent may not be provided according to the use and the structure of the lithium battery.

Next, a separator to be disposed between the positive electrode and the negative electrode is prepared.

The separator for the lithium battery may be any suitable separator that is commonly utilized in lithium batteries. The separator may have low resistance to migration of ions in an electrolyte and have electrolyte -retaining ability. Non-limiting examples of the separator may include glass fiber, polyester, Teflon, polyethylene, polypropylene, polytetrafluoroethylene (PTFE), and a combination thereof, each of which may be a non-woven or woven fabric. For example, a rollable separator including polyethylene or polypropylene may be utilized for a lithium ion battery. A separator with a good or suitable organic electrolyte -retaining ability may be utilized for a lithium ion polymer battery. For example, in one or more embodiments, the separator may be manufactured in the following manner.

A polymer resin, a filler, and a solvent may be mixed together to prepare a separator composition. Then, the separator composition may be directly coated on an electrode, and then dried to form the separator. In some embodiments, the separator composition may be cast on a support and then dried to form a separator film, which may then be separated from the support and laminated on the electrode to form the separator.

The polymer resin utilized to manufacture the separator may be any suitable material that is commonly utilized as a binder for electrode plates. Non-limiting examples of the polymer resin may include a vinylidenefluoride/hexafluoropropylene copolymer, polyvinylidene fluoride (PVDF), polyacrylonitrile, polymethylmethacrylate, and a mixture thereof.

Then, the electrolyte solution, according to the above-described embodiments, is prepared.

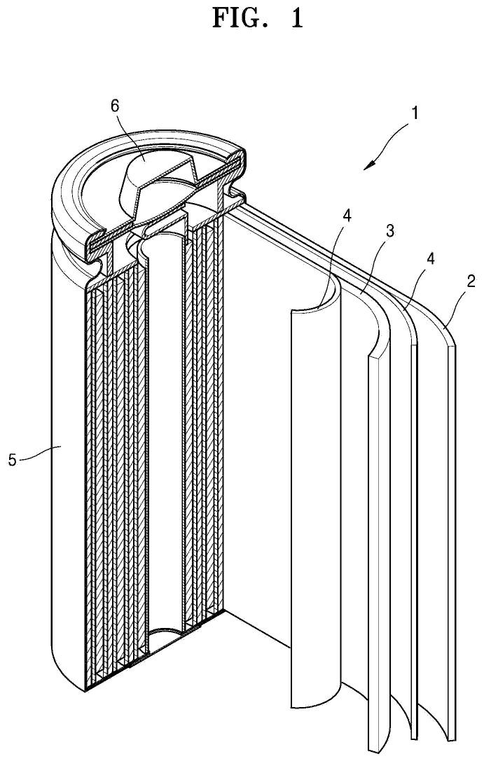

As shown in FIG. 1, a lithium battery 1 may include a positive electrode 3, a negative electrode 2, and a separator 4. The positive electrode 3, the negative electrode 2, and the separator 4 may be wound or fold to be accommodated in a battery case 5. Then, the battery case 5 is filled with an organic electrolyte solution and sealed with a cap assembly 6, thereby completing the manufacture of the lithium battery 1. The battery case 5 may be a cylindrical type or kind, a rectangular type or kind, or a thin-film type or kind. For example, the lithium battery 1 may be a thin-film type or kind battery. In one or more embodiments, the lithium battery 1 may be a lithium ion battery.

In one or more embodiments, the separator may be disposed between the positive electrode and the negative electrode to provide a battery assembly. The battery assembly may be stacked in a bi-cell structure and impregnated with an electrolyte solution, and put into a pouch and hermetically sealed, thereby completing the manufacture of a lithium-ion polymer battery.

In one or more embodiments, a plurality of battery assemblies may be stacked to form a battery pack, which may be utilized in a device that requires large capacity and high power, for example, in a laptop computer, a smartphone, or an electric vehicle.

In the lithium secondary battery according to one or more embodiments, a direct current internal resistance (DCIR) increase rate is significantly reduced, thereby exhibiting excellent or suitable battery characteristics, as compared with a lithium secondary battery employing a general nickel-rich lithium-nickel composite oxide as a positive active material.

The operating voltage of the lithium secondary battery to which the positive electrode, the negative electrode, and the electrolyte are applied has a lower limit of 2.5 V to 2.8 V and an upper limit of 4.1 V or more, for example, 4.1 V to 4.45 V.

Non-limiting examples of the lithium secondary battery may include power tools powered by an electric motor; electric cars, e.g., electric vehicles (eVs), hybrid electric vehicles (HEVs), plug-in hybrid electric vehicles (PHEVs); electric two-wheeled vehicles, e.g., e-bikes and e-scooters; electric golf carts; and power storage systems. However, embodiments of the device are not limited thereto.

The term “alkyl group” as utilized herein may refer to a branched or unbranched aliphatic hydrocarbon group. In one embodiment, the alkyl group may be substituted or unsubstituted. Non-limiting examples of the alkyl group may include a methyl group, an ethyl group, a propyl group, an iso-propyl group, a butyl group, an isobutyl group, a tert-butyl group, a pentyl group, a hexyl group, a cyclopropyl group, a cyclopentyl group, a cyclohexyl group, and a cycloheptyl group, each of which may optionally be substituted in some embodiments. In some embodiments, an alkyl group may include 1 to 6 carbon atoms. For example, an alkyl group having 1 to 6 carbon atoms may be a methyl group, an ethyl group, a propyl group, an iso-propyl group, a butyl group, an isobutyl group, a sec-butyl group, pentyl group, 3-pentyl group, and a hexyl group, but embodiments of the present disclosure are not limited thereto.

At least one hydrogen atom of the alkyl group may be substituted with a halogen, a C₁-C₂₀ alkyl group (for example, CF₃, CHF₂, CH₂F, CCl₃, and/or the like) substituted with a halogen, a C₁-C₂₀ alkoxy group, a C₂-C₂₀ alkoxyalkyl group, a hydroxyl group, a nitro group, a cyano group, an amino group, an amidino group, hydrazine, hydrazone, a carboxyl group or a salt thereof, a sulfonyl group, a sulfamoyl group, a sulfonic acid group or a salt thereof, a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₇-C_{20 20} arylalkyl group, a C₆-C₂₀ heteroaryl group, a C₇-C₂₀ heteroarylalkyl group, a C₆-C₂₀ heteroaryloxy group, or a C₆-C₂₀ heteroaryloxyalkyl group.

As utilized herein, the “alkenyl group” may include, but is not limited to, an ethenyl group, a 1-propenyl group, a 2-propenyl group, a 2-methyl-1-propenyl group, a 1-butenyl group, a 2-butenyl group, a cyclopropenyl group, a cyclopentenyl group, a cyclohexenyl group, and a cyclopentenyl group, as a hydrocarbon group of 2 to 20 carbon atoms having at least one carbon-carbon double bond. For example, an alkenyl group may be substituted or unsubstituted. In some embodiments, the alkenyl group may have 2 to 40 carbon atoms.

The term “alkynyl group” as utilized herein may refer to a hydrocarbon group including 2 to 20 carbon atoms with at least one carbon-carbon triple bond. Non-limiting examples thereof may include an ethynyl group, a 1-propynyl group, a 1-butynyl group, and a 2-butynyl group. For example, an alkynyl group may be substituted or unsubstituted. In some embodiments, the alkynyl group may have 2 to 40 carbon atoms.

As utilized herein, a substituent is derived from an unsubstituted parent group, wherein at least one hydrogen atom is substituted with another atom or functional group. Unless otherwise specified, when a functional group is considered to be “substituted,” it may refer to that the functional group is substituted with at least one substituent independently selected from the group consisting of a C₁-C₂₀ alkyl group, a C₂-C₂₀ alkenyl group, a C₂-C₂₀ alkynyl group, a C₁-C₂₀ alkoxy group, a halogen, a cyano group, a hydroxy group, and a nitro group. When a functional group is described as being “optionally substituted”, the functional group may be substituted with the aforementioned substituent.

The term “halogen” as utilized herein may refer to fluorine, bromine, chlorine, or iodine.

The “alkoxy” refers to “alkyl-O-”, where alkyl may be as defined above. Non-limiting examples of the alkoxy group may include a methoxy group, an ethoxy group, a 2-propoxy group, a butoxy group, a t-butoxy group, a pentyloxy group, and a hexyloxy group. At least one hydrogen atom of the alkoxy group may be substituted with a substituent as described with respect to the alkyl group.

The term “heteroaryl group” as utilized herein may refer to a monocyclic or bicyclic organic compound including at least one heteroatom selected from nitrogen (N), oxygen (O), phosphorous (P), and sulfur (S), wherein the rest of the cyclic atoms are all carbon atoms. The heteroaryl group may include, for example, one to five heteroatoms. In some embodiments, the heteroaryl group may include a five to ten ring member. In the heteroaryl group, S or N may be oxidized to have one or more suitable oxidation states.

Non-limiting examples of the heteroaryl group may include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and 5-pyrimidin-2-yl.

The term “heteroaryl” group as utilized herein may include a group having a heteroaromatic ring fused to at least one aryl, cycloaliphatic, or heterocyclic ring.

The term “carbocyclic” may refer to a saturated or partially unsaturated non-aromatic monocyclic, bicyclic, or tricyclic hydrocarbon group.

Non-limiting examples of the monocyclic hydrocarbon group may include cyclopentyl, cyclopentenyl, cyclohexyl, and cyclohexcenyl.

Non-limiting examples of the bicyclic hydrocarbon group may include bornyl, decahydronaphthyl, bicyclo [2.1.1] hexyl, bicyclo [2.1.1] heptyl, bicyclo[2.2.1]heptenyl, and bicyclo[2.2.2]octyl.

Non-limiting examples of the tricyclic hydrocarbon may include adamantyl.

At least one hydrogen atom of the “carbocyclic” group may be substituted with a substituent as utilized in the alkyl group described above.

Hereinafter example embodiments will be described in more detail with reference to Examples and Comparative Examples. These examples are provided for illustrative purposes only and are not intended to limit the scope of the present disclosure.

### Preparation Example 1: Preparation of Compound represented by Formula 4

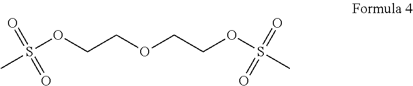

The compound of Formula 4 was prepared as follows.

(By: Muehlebach, Michel; et al Bioorganic & Medicinal Chemistry (2009), 17(12), 4241-4256)

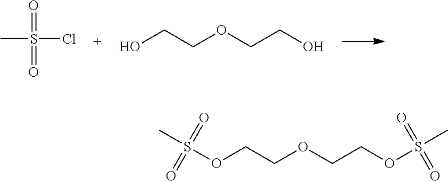

The structure of the compound of Formula 4 was confirmed through nuclear magnetic resonance analysis.

### Preparation of Lithium Secondary Battery

### Example 1

1.0 M of LiPF₆ was added to a mixed solvent having a volume ratio of ethylene carbonate (EC), ethylmethyl carbonate (EMC), and dimethyl carbonate (DMC) of 20:20:60, and then the compound of Formula 4 obtained according to Preparation Example 1 was added thereto in an amount of 0.2 wt % to prepare an electrolyte for a lithium secondary battery, based on the total weight of the electrolyte.

97 wt % of LiNi_{0.8}Co_{0.1}Al_{0.1}O₂ as a positive active material, artificial 0.5 wt % of graphite powder (SFG6, Timcal) as a conductive agent, 0.8 wt % of carbon black (Ketjen black, ECP), 0.2 wt % of modified acrylonitrile rubber (BM-720H, Zeon Corporation), 1.2 wt % of polyvinylidene fluoride (PVdF, S6020, Solvay), and 0.3 wt % of polyvinylidene fluoride (PVdF, S5130, Solvay) were mixed and added to N-methyl-2-pyrrolidone, followed by stirring for 30 minutes by utilizing a mechanical stirrer, thereby preparing a positive active material slurry. The positive active material slurry was coated on an aluminum current collector having a thickness of μm to a thickness of 60 μm utilizing a doctor blade. By drying at a temperature of 100° C. utilizing a hot-air dryer for 0.5 hours and vacuum-drying at a temperature of 120° C. for 4 hours and roll-pressing, a positive electrode was prepared.

A negative active material slurry was prepared by mixing artificial graphite as a negative active material and polyvinylidene fluoride as a binder in a weight ratio of 98:2 and dispersing the mixture in N-methyl pyrrolidone. The positive active material slurry was coated on a copper current collector having a thickness of 10 μm to a thickness of 60 μm utilizing a doctor blade. By drying at a temperature of 100° C. utilizing a hot-air dryer for 0.5 hours and vacuum-drying at a temperature of 120° C. for 4 hours and roll-pressing, a negative electrode was prepared.

A lithium secondary battery was manufactured utilizing the prepared positive electrode, the prepared negative electrode, a 14 μm-thick polyethylene separator, and the electrolyte.

### Examples 2 to 5

Lithium secondary batteries were manufactured in substantially the same manner as in Example 1, except that the content (e.g., amount) of the compound represented by Formula 4 was 0.5 wt %, 0.75 wt %, 1.0 wt %, and 2.0 wt %, respectively.

### Comparative Example 1

A lithium secondary battery was manufactured in substantially the same manner as in Example 1, except that an electrolyte not added with the compound represented by Formula 4 was utilized.

### Comparative Example 2

A lithium secondary battery was manufactured in substantially the same manner as in Example 1, except that an electrolyte only added with 0.2 wt % of a compound represented by Formula 13 (ethan-1, 2-diyl dimethanesulfonate) was utilized. The compound represented by Formula 13 was synthesized according to the preparation method by: Tahtaoui, Chouaib; et al Journal of Medicinal Chemistry (2004), 47(17), 4300-4315.

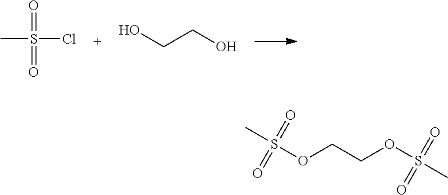

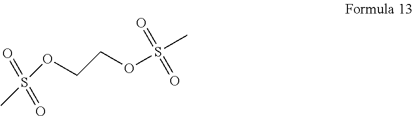

### Comparative Example 3

A lithium secondary battery was manufactured in substantially the same manner as in Example 1, except that an electrolyte only added with 0.2 wt % of a compound represented by Formula 14 was utilized. The compound represented by Formula 14 was prepared according to the preparation method disclosed in JP 2008-218425A.

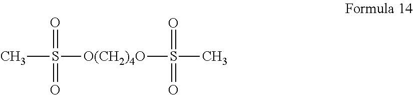

### Evaluation Example 1: Evaluation of High-temperature (60° C.) Initial DC Resistance (DC-IR) and DC-IR Increase Rate After High-temperature Storage

The lithium secondary batteries manufactured in Examples 1 to 5 and Comparative Examples 1 to 3 under a charging condition of 0.2 C and 4.2 V at a temperature of 25° C. were then stored in an oven at a temperature of 60° C. for 30 days. Then, the DC-IR of each of the lithium secondary batteries was measured to evaluate the DC-IR increase rate before and after storage. The results of evaluation are shown in Table 1. After measuring the initial DC-IR before storing each of the lithium secondary batteries, the DC-IR was measured after storing at a high temperature of 60° C. for 30 days, and the DC-IR change rate (%) was calculated according to Equation 1:

DC-IR change rate=[DCIR(30d.)−DCIR(0d.)]/DCIR(0d.)×100%, Equation 1

wherein, in Equation 1, “DCIR(30d.)” indicates DC-IR after 30 days, and “DC-IR (0d.)” indicates DC-IR right before the storage.

The initial DC-IR, DC-IR after high temperature storage, and DC-IR change rate measurement results are shown in Table 1.

### Evaluation Example 2: Evaluation of Gas Generation During High-temperature Storage

The lithium secondary batteries of Examples 1 to 5 and Comparative Example 1 were charged with a constant current with 0.2 C at a temperature of 25° C. until the voltage reached 4.4 V. Subsequently, the lithium secondary batteries were cut-off charged with a constant voltage with 0.05 C while maintaining 4.4 V. The lithium secondary batteries were stored in an oven at 85° C. for 8 hours. The mass change due to the volume change of the pouch was converted by the Archimedes method, and the results are shown in Table 1.

The electrolyte was a mixed solvent of ethylene carbonate (EC), diethyl carbonate (DEC), and ethylmethyl carbonate (EMC) at a volume ratio of 2:4:4 in which 1.5 M LiPF₆ was dissolved.

The Archimedes method is a method of measuring the amount of gas generated by weighing the pouch in a water tank filled with water every specific period (e.g., 4 days) and converting the weight change into volume.

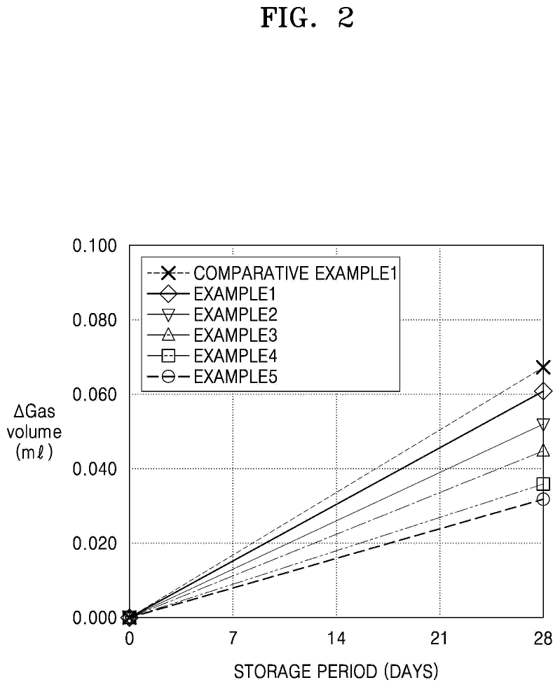

The results of measurement of gas generation during high-temperature storage are shown in Table 1. FIG. 2 shows the change in gas generation volume according to the storage date.

TABLE 1

| | | DC-IR change rate | Amount of gas |
|---|---|---|---|
| | Content of | after storage at 60° C. | after storage |
| | additive | for 30 days | at 60° C. |
| Classification | (wt %) | (%) | (mL) |
| Example 1 | 0.2 | 51 | 0.061 |
| Example 2 | 0.5 | 41 | 0.052 |
| Example 3 | 0.75 | 33 | 0.045 |
| Example 4 | 1.0 | 25 | 0.036 |
| Example 5 | 2 | 30 | 0.032 |
| Comparative | 0 | 92 | 0.067 |
| Example 1 | | | |
| Comparative | 0.2 | 75 | 0.065 |
| Example 2 | | | |
| Comparative | 0.2 | 83 | 0.064 |
| Example 3 | | | |

As shown in Table 1 and FIG. 2, when storing the lithium secondary batteries of Examples 1 at a high temperature for a long-term, the DC-IR value was low, the DC-IR increase rate was reduced, and the gas content (e.g., amount) after storing at 60° C. was also reduced, as compared with the lithium secondary battery of Comparative Example 1 not including the compound of Formula 4,

When storing the lithium secondary battery of Comparative Example 2 including the electrolyte containing the compound of Formula 13 and the lithium secondary battery of Comparative Example 3 including the electrolyte containing the compound of Formula 14 in a high temperature for a long-term, as compared with the lithium secondary battery of Example 1, it may be seen that the DC-IR value was high during high temperature storage, the DC-IR increase rate also increased, and the gas content (e.g., amount) increased after being stored at 60° C.

### Evaluation Example 3: Evaluation of Lifespan Characteristics at High Temperature (60° C.)

Each of the lithium secondary batteries manufactured in Examples 1 to 5 and Comparative Examples 1 to 3 was charged with a constant current of 0.1 C rate at 25 10° C. until the voltage reached 4.3 V (vs. Li), and the constant voltage of 4.3 V (constant voltage mode) was maintained until a cutoff current of 0.05 C rate was reached. Afterward, the batteries were discharged with a constant current of 0.1 C rate until the voltage reached 2.8 V (vs. Li) (formation process, 1st cycle).

Each of the lithium secondary batteries that underwent the 1st cycle of the formation process was charged with a constant current of 0.2 C rate at 25° C. until the voltage reached 4.3 V (vs. Li), and a constant voltage of 4.3 V (constant voltage mode) was maintained until a cutoff current of 0.05 C rate was reached. Subsequently, the batteries were discharged with a constant current of 0.2 C rate until the voltage reached 2.8 V (vs. Li) (Formation process, 2^{nd} cycle).

Each of the lithium secondary batteries that underwent the formation process was charged with a constant current of 0.5 C rate at 60° C. until the voltage reached 4.3 V (vs. Li), and a constant voltage of 4.3 V (constant voltage mode) was maintained until a cutoff current of 0.05 C rate was reached. Afterward, each of the lithium secondary batteries was discharged at a constant current of 1.0 C rate until the voltage reached 2.8 V (vs. Li). This charging and discharging cycle was performed 300 times.

During all these charge/discharge cycles, after one charge/discharge cycle, the evaluation was paused for 10 minutes.

The lifespan characteristics at a high temperature, the capacity retentions at 150^{th} and 300^{th} cycles were evaluated. The results thereof are shown in Table 2. The capacity retention at the 300^{th} cycle may be defined by Equation 2:

Capacity retention (%)=(discharge capacity at the 300^{th} cycle/discharge capacity at the 1^{st} cycle)×100% Equation 2

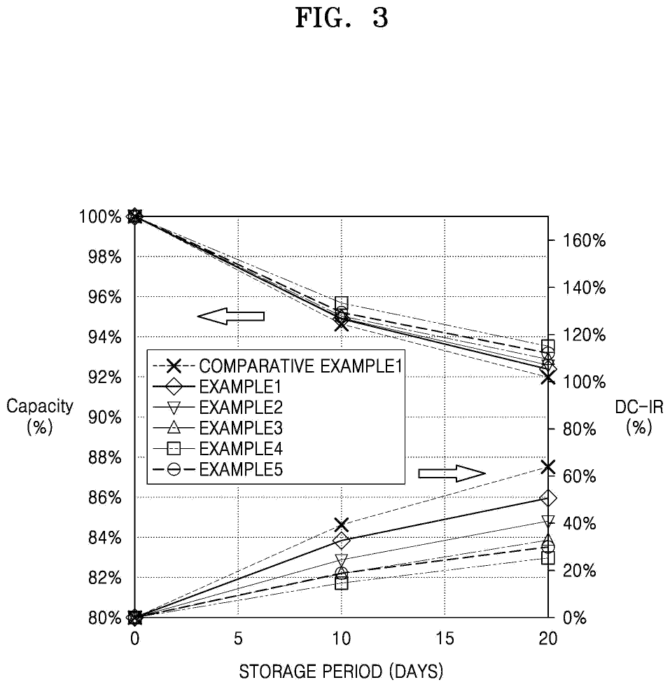

The evaluation results of capacity retention are as shown in Table 2 and FIG. 3.

TABLE 2

| | Capacity retention |
|---|---|
| Classification | (%) |
| Example 1 | 92 |
| Example 2 | 92 |
| Example 3 | 93 |
| Example 4 | 93 |
| Example 5 | 94 |
| Comparative Example 1 | 92 |
| Comparative Example 2 | 90 |
| Comparative Example 3 | 89 |

Referring to Table 1, the lithium secondary batteries of Examples 1 to 5 each had a reduced DC-IR and a reduced gas generation amount, as compared with the lithium secondary batteries of Comparative Examples 1 to 3. As shown in Table 2, the lithium secondary batteries of Examples 1 to 5 were found to have improved lifespan characteristics at a high temperature, as compared with the lithium secondary battery of Comparative Example 1.

As apparent from the foregoing description, when the electrolyte for a lithium secondary battery according to one or more embodiments is utilized, Gas generation may be effectively suppressed or reduced when left at high temperatures, thus improving lifespan characteristics of the lithium secondary battery.

In the present disclosure, singular expressions may include plural expressions unless the context clearly indicates otherwise. It will be further understood that the terms “comprise,” “include,” and “have” when utilized in the present disclosure, specify the presence of stated features, integers, steps, operations, elements, and/or components, but do not preclude the presence or addition of one or more other features, integers, steps, operations, elements, components, and/or groups thereof. The “/” utilized herein may be interpreted as “and” or as “or” depending on the situation.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure”.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the disclosure as defined by the following claims and equivalents thereof.

What is claimed is:

1. An electrolyte for a lithium secondary battery, the electrolyte comprising:
a lithium salt; an organic solvent; and a compound represented by Formula 1: 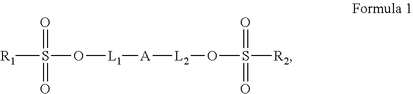
wherein, in Formula 1, L₁ and L₂ are each independently an unsubstituted or substituted C₁-C₂₀ alkylene group, an unsubstituted or substituted C₂-C₄ alkynylene group, an unsubstituted or substituted C₆-C₂₀ arylene group, or an unsubstituted or substituted C₆-C₂₀ heteroarylene group,
A is oxygen (O) or sulfur (S), and
R₁ and R₂ are each independently selected from hydrogen, deuterium, a fluoro group (—F), a chloro group (—Cl), a bromo group (—Br), an iodo group (—I), a hydroxyl group, a cyano group, a nitro group, an amino group, an am idino group, a hydrazine group, a hydrazone group, a carboxylic acid group or a salt thereof, a sulfonic acid group or a salt thereof, a phosphoric acid group or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non-aromatic condensed polycyclic group, a substituted or unsubstituted monovalent non-aromatic condensed heteropolycyclic group, —N(Q₁)(Q₂), and —B(Q₆)(Q₇), wherein Q₁, Q₂, Q₆, and Q₇ are each independently hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, or a monovalent non-aromatic condensed heteropolycyclic group.

2. The electrolyte of claim 1, wherein the compound is a compound represented by Formula 2: 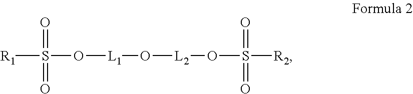
and
wherein, in Formula 2, L₁ and L₂ are each independently an unsubstituted or substituted C₁-C₂₀ alkylene group, an unsubstituted or substituted C₂-C₄ alkynylene group, an unsubstituted or substituted C₆-C₂₀ arylene group, or an unsubstituted or substituted C₆-C₂₀ heteroarylene group, and
R₁ and R₂ are each independently selected from hydrogen, deuterium, a fluoro group (—F), a chloro group (—Cl), a bromo group (—Br), an iodo group (—I), a hydroxyl group, a cyano group, a nitro group, an amino group, an am idino group, a hydrazine group, a hydrazone group, a carboxylic acid group or a salt thereof, a sulfonic acid group or a salt thereof, a phosphoric acid group or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non- aromatic condensed polycyclic group, a substituted or unsubstituted monovalent non-aromatic condensed heteropolycyclic group, —N(Q₁)(Q₂), and —B(Q₆)(Q₇), wherein Q₁, Q₂, Q₆, and Q₇ are each independently hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, or a monovalent non-aromatic condensed heteropolycyclic group.

3. The electrolyte of claim 1, wherein the compound is a compound represented by Formula 3: 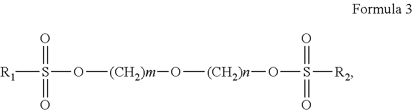
and
wherein, in Formula 3, R₁ and R₂ are each a substituted or unsubstituted C₁-C₂₀ alkyl group, and
m and n are each independently an integer from 1 to 10.

4. The electrolyte of claim 3, wherein, in Formula 3, R₁ and R₂ are each a C₁-C₂₀ alkyl group.

5. The electrolyte of claim 3, wherein, in Formula 3, m and n are each independently 2 or 3.

6. The electrolyte of claim 1, wherein the compound is selected from compounds represented by Formulae 4 to 6:

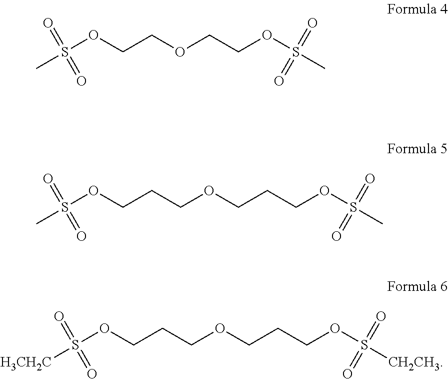

7. The electrolyte of claim 1, wherein an amount of the compound is in a range of about 0.05 percent by weight (wt %) to about 20 wt %, based on a total weight of the electrolyte.

8. The electrolyte of claim 1, wherein the lithium salt is at least one selected from the group consisting of LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), LiPO₂F₂, and compounds represented by Formulae 7 to 10:

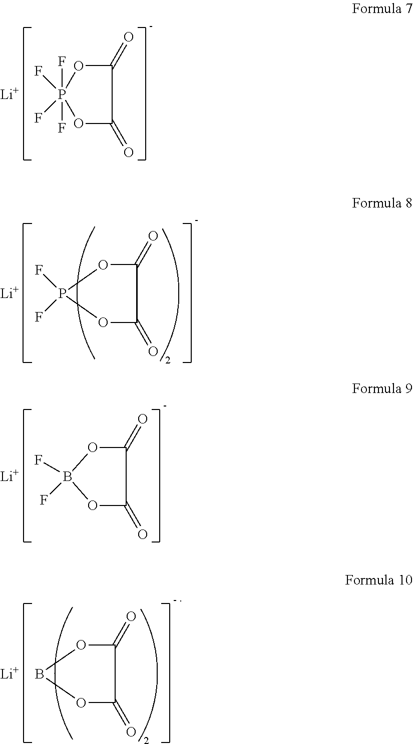

9. The electrolyte of claim 1, wherein a concentration of the lithium salt is in a range of about 0.01 molar (M) to about 5.0 M.

10. The electrolyte of claim 1, wherein the organic solvent comprises at least one selected from the group consisting of ethylmethyl carbonate (EMC), methylpropyl carbonate, ethylpropyl carbonate, dimethyl carbonate (DMC), diethyl carbonate(DEC), dipropyl carbonate, propylene carbonate (PC), ethylene carbonate (EC), fluoroethylene carbonate (FEC), vinylene carbonate (VC), vinylethylene carbonate (VEC), butylene carbonate, ethyl propionate, ethyl butyrate, dimethyl sulfoxide, dimethyl formamide, dimethyl acetamide, γ-valerolactone, γ-butyrolactone, and tetrahydrofuran.

11. A lithium secondary battery comprising:
a positive electrode comprising a positive active material;
a negative electrode comprising a negative active material; and
the electrolyte of claim 1 between the positive electrode and the negative electrode.

12. The lithium secondary battery of claim 11, wherein the positive electrode comprises a compound represented by Formula 12:
LiₐNiₓCo_{y}M_{z}O_{2-b}X_{b} Formula 12
wherein, in Formula 12, 1.0≤a≤1.2, 0≤b≤0.2, 0.6≤x≤1, 0≤0.3, 0≤z≤0.3, and x+y+z=1,
M is at least one selected from the group consisting of manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), and boron (B), and
X is F, S, Cl, Br, or a combination thereof.

13. The lithium secondary battery of claim 11, wherein A is oxygen.

14. The lithium secondary battery of claim 11, wherein the compound is a compound represented by Formula 3: 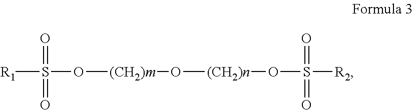
and
wherein, in Formula 3, R₁ and R₂ are each a substituted or unsubstituted C₁-C₂₀ alkyl group, and
m and n are each independently an integer from 1 to 10.

15. The lithium secondary battery of claim 13, wherein, in Formula 3, R₁ and R₂ are each a C₁-C₂₀ alkyl group.

16. The lithium secondary battery of claim 13, wherein, in Formula 3, m and n are each independently 2 or 3.

17. The lithium secondary battery of claim 11, wherein the compound is selected from compounds represented by Formulae 4 to 6:

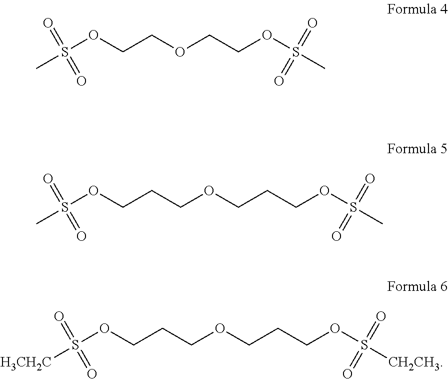

18. The lithium secondary battery of claim 11, wherein an amount of the compound is in a range of about 0.05 percent by weight (wt %) to about 20 wt %, based on a total weight of the electrolyte.

19. The lithium secondary battery of claim 11, wherein the lithium salt is at least one selected from the group consisting of LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), LiPO₂F₂, and compounds represented by Formulae 7 to 10:

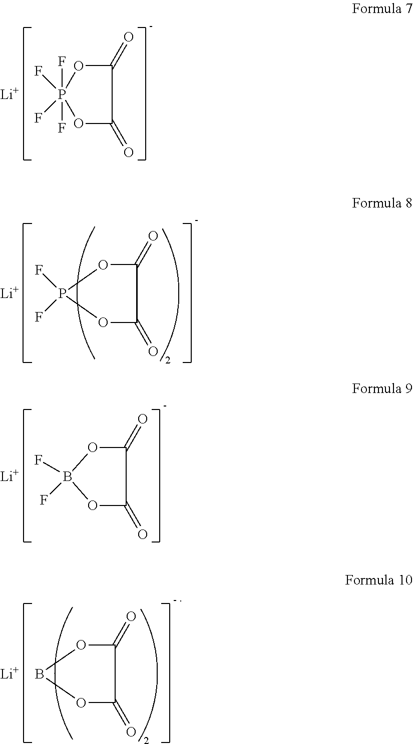

20. The lithium secondary battery of claim 11, wherein a concentration of the lithium salt is in a range of about 0.01 molar (M) to about 5.0 M.
